(19) United States
(12) Patent Application Publication
(10) Pub. No.: US 2026/0230921 A1
(43) Pub. Date: Aug. 6, 2026

(54) DEVICES, METHODS, AND MEDIUM FOR COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 19/149,904

(22) PCT Filed: Feb. 7, 2023
(86) PCT No.: PCT/CN2023/074829

§ 371 Date: Jul. 22, 2025

(51) Int. Cl. H04W 28/02; H04W 28/06; H04W 80/02

(52) U.S. Cl. CPC H04W 28/0278; H04W 28/06; H04W 80/02

(57) ABSTRACT

Example embodiments of the present disclosure relate to a solution for buffer status report (BSR) enhancements. In this solution, a terminal device transmits, to a network device, delay information for at least one buffered data packet, the delay information indicating at least one of the following: a reference time related to buffering of the at least one data packet, a first time interval between an arrival time of the at least one data packet and a time when a BSR is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval.

### FIELDS

Example embodiments of the present disclosure generally relate to the field of communication techniques and in particular, to devices, methods, and medium for buffer status report (BSR) enhancements.

### BACKGROUND

Efforts have been made to develop communication systems to meet the increasing demand for wireless data traffic. In new radio (NR) communication and a plurality of other types of wireless communications systems, various types of services, for example, the extended Reality (XR) service, need to be supported. These services have a higher requirement on a transmission latency of the wireless communications systems.

In communications networks, a terminal device wishing to send data will transmit a buffer status report (BSR) to a network device indicating the amount of data it has buffered for transmission. In response, the network device allocates appropriate uplink resources and transmission opportunities to the terminal device so that it can transmit its data.

### SUMMARY

In general, embodiments of the present disclosure provide devices, methods, and computer storage medium for BSR enhancements.

In a first aspect, there is provided a first communication device. The device comprises a processor configured to cause the first communication device to: transmit, to a network device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval.

In a second aspect, there is provided a second communication device. The device comprises a processor configured to cause the second communication device to: receive, from a terminal device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval; and determine a remaining delay budget for the at least one data packet based on the delay information.

In a third aspect, there is provided a communication method. The method comprises: transmitting, from a terminal device and to a network device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval.

In a fourth aspect, there is provided a communication method. The method comprises: receiving, at a network device and from a terminal device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus a first time interval between an arrival time of the at least one data packet and a time when a buffer status report (BSR) is transmitted, a second time interval between the arrival time of the at least one data packet and a time when a resource for transmission of the BSR is granted, or a second result of the delay budget for the at least one data packet minus the second time interval; and determining a remaining delay budget for the at least one data packet based on the delay information.

In a fifth aspect, there is provided a computer readable medium. The computer readable medium has instructions stored thereon, the instructions, when executed on at least one processor, causing the at least one processor to perform the method according to the third aspect or the fourth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow for communication in accordance with some embodiments of the present disclosure;

FIG. 3 illustrates an example timeline showing various events occurred from the time when buffering of a data packet starts to the time when a BSR is received by the network device;

FIGS. 4A-4C illustrate example formats of BSR MAC CE in accordance with some embodiments of the present disclosure;

FIGS. 5A-5C illustrate example formats of BSR MAC CE in accordance with some other embodiments of the present disclosure;

FIGS. 6A-6B illustrate example timelines showing various events occurred from the time when a latest BSR is transmitted to the time when a new BSR is received by the network device;

FIG. 7 illustrates a flowchart of a method implemented at a terminal device in accordance with some embodiments of the present disclosure;

FIG. 8 illustrates a flowchart of a method implemented at a network device in accordance with some embodiments of the present disclosure; and

FIG. 9 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some embodiments of the present disclosure. It is noted that example embodiments of the present disclosure are equally applicable to other resources in other domains.

Embodiments of the present disclosure provide a solution for BSR enhancements. Principles and implementations of the present disclosure will be described in detail below with reference to the figures.

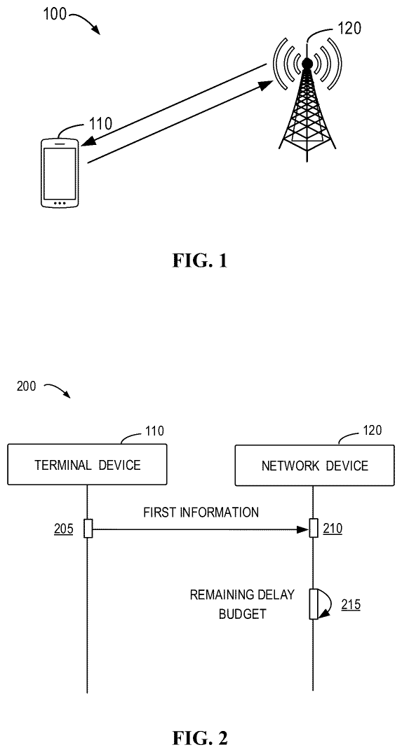

FIG. 1 illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1, the network device 120 may be a base station serving the terminal device 110. The serving area of the network device 120 may be called a cell (not shown). In the communication environment 100, the network device 120 and the terminal devices 110 may communicate data and control information to each other.

It is to be understood that the number of devices and their connections in FIG. 1 are given for the purpose of illustration without suggesting any limitations to the present disclosure. The communication environment 100 may include any suitable number of devices adapted for implementing embodiments of the present disclosure. For example, there may be more terminal devices and/or network devices in the communication environment 100. Although not shown, the communication environment 100 may involve a core network with core network devices for supporting the communications.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In the communication environment 100, the terminal device 110 may communicate with one or more network devices 120. In some embodiments, the network device 120 may include a transmission-reception point (TRP). The network device 120 which serves the terminal device 110 may be referred to as a serving network device of the terminal device 110. In some example embodiments, a link from a network device 120 to the terminal device 110 is referred to as a downlink (DL), while a link from the terminal device 110 to a network device 120 is referred to as an uplink (UL).

In communications networks, a terminal device and a network device may communicate traffic data, control information and the like with each other. In some cases, the terminal device may transmit a buffer status report (BSR) to a network device indicating the amount of data it has buffered for transmission. As a response, the network device allocates appropriate uplink resources and transmission opportunities to the terminal device so that it can transmit its data.

Various real-time applications may be delay-sensitive, requiring a relatively short delay with a relatively minimal delay variation. Examples of real-time applications include extended Reality (XR) applications, multimedia applications, voice-over-internet protocol (VOIP), video-conferencing applications, virtual reality applications and online games. In particular, a latency issue may appreciably affect the user experience, such as when an online mobile game is repeatedly paused or lags due to issues originating at lower layers of a radio protocol stack (e.g., due to radio impairments).

In some applications, any data which has exceeded a certain delay budget may not be useful. Therefore, the uplink resources need to be allocated before then. Therefore, it is desired that the termina device can perform delay reporting of buffered data in uplink.

According to example embodiments of the present disclosure, there is provided a solution for BSR enhancements. In this solution, a terminal device transmits delay information for at least one data packet to a network device. The delay information can indicate specific delay time and delay time interval related information which allows the network device to determine a remaining delay budget for at least one data packet. Through this solution, the network device can have flexibility for resource scheduling considering the remaining delay budget for the data packet(s) and hence improve the capacity by prioritizing the scheduling of the corresponding delayed data.

Example embodiments of the present disclosure will be described in detail below.

FIG. 2 illustrates a signaling flow 200 for communication in accordance with some embodiments of the present disclosure. For the purpose of discussion, the signaling flow 200 will be described with reference to FIG. 1, and the terminal device 110 and the network device 120 are involved in the signaling flow 200.

In the signaling flow 200, the terminal device 110 transmits (205), to the network device 120, delay information for at least one data packet buffered at the terminal device 110. The delay information is to provide appropriate information for the network device 120 to derive a remaining delay budget for the at least one data packet when the delay information is received by the network device 120. Hence, upon receipt (210) of the delay information, the network device 120 determines (215) a remaining delay budget for the at least one data packet based on the delay information. In some embodiments, the remaining delay budget may be determined at least with respect to the time when the delay information is received. In some embodiments, the delay information may be transmitted in a BSR to the network device 120, although separate transmissions of the delay information and other data buffer status information are also feasible.

As used herein, a data packet may refer to any appropriate unit of data. Generally, each protocol layer may receive a data packet from an upper layer, process the data packet to generate a new data packet, and then transmit the new data packet to a lower protocol layer. At each protocol layer, the data packet from the upper layer may be referred to as a service data unit (SDU), and the data packet generated at the protocol layer is referred to as a protocol data unit (PDU). Therefore, in two adjacent protocol layers, a PDU of an upper protocol layer may be considered as an SDU of a lower protocol layer.

In some embodiments, delay information may be determined per data packet, e.g., per PDU or per SDU. In some embodiments, delay information may be determined per data packet set, e.g., per PDU set. A PDU set is composed of one or more data packets (e.g., one or more PDUs) carrying the payload of one unit of information generated at the application level (e.g., a frame or video slice for XR media, XRM, services). In some implementations, all PDUs in a PDU set are needed by the application layer to use the corresponding unit of information. In other implementations, the application layer can still recover parts all or of the information unit, when some PDUs are missing.

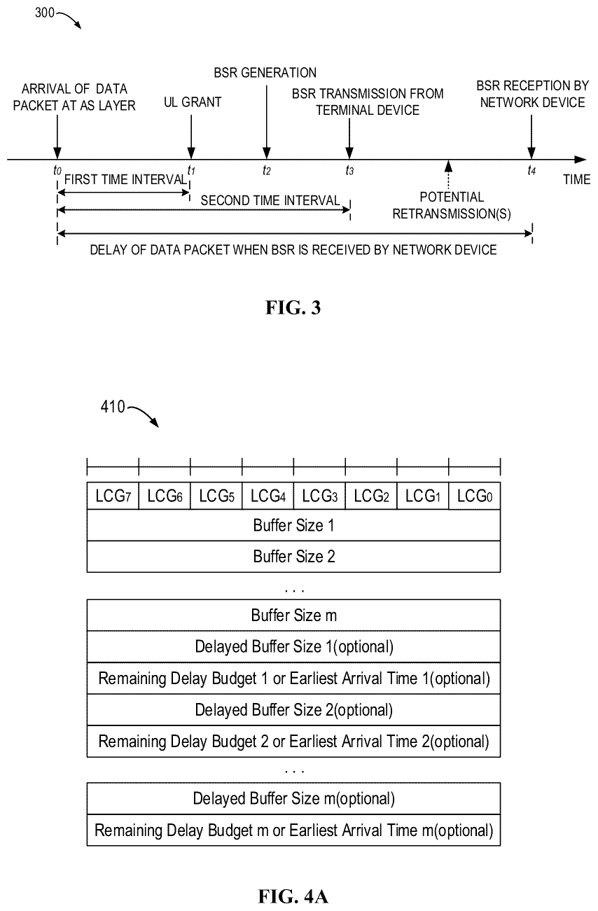

The buffering delay may be caused by various reasons. The delay occurs from the time when a data packet is buffered. FIG. 3 illustrates an example timeline 300 showing various events occurred from the time when buffering of a data packet starts to the time when a BSR is received by the network device. As illustrated, it is assumed that at least one data packet (e.g., a PDU or a PDU set) arrives at an access stratum (AS) layer from an upper layer the time t₀. This time t₀ may also be referred to as an arrival time of the at least one data packet at the AS layer. A resource for transmission of delay information (or a BSR) is granted at the time t₁. The terminal device 110 generates the BSR related to the at least one data packet at the time t₂. The BSR is transmitted at the time t₃, for example, on a Uu interface. The time t₃ may be determined based on the granted resource. In some embodiments, the transmission of the BSR at the time t₃ is a new transmission (i.e., an initial transmission). According to a Hybrid Automatic Repeat request (HARQ) mechanism, one or more retransmission of the BSR may happen after the initial transmission. The BSR is received by the network device 120 at the time t₄.

In some embodiments, the delay information may indicate a reference time related to buffering of at least one data packet (a single packet, e.g., a PDU, a SDU, or a set of data packets, e.g., a PDU set). In some embodiments, the reference time may comprise an arrival time of the at least one data packet at the AS layer, e.g., the time t₀ as illustrated in FIG. 3, which may be the beginning of buffering of the at least one data packet. In some embodiments, the reference time may be any time that is known to both the terminal device 110 and the network device 120. This reference time may be set with respect to the arrival time of the at least one data packet, e.g., as having a predefined time duration with respect to the arrival time t₀. In some embodiments, the reference time may be indicated in units of symbol in a time slot or in any other suitable time units.

At the side of the network device 120, it may determine a remaining delay budget for the at least one data packet based on the reference time indicated by the delay information. Specifically, the network device 120 may determine a time interval (sometimes referred to as a “third time interval” herein) between the reference time and a time when the BSR is received, e.g., the time t₄ in FIG. 3. In the case that the reference time is to in FIG. 3, the time interval is determined as (t₄−t₀). Since the network device 120 may be aware of when the BSR (reporting a buffer status of the at least one data packet) is received, the network device 120 may thus be capable of deriving the time interval (t₄−t₀). The network device 120 may be aware of a delay budget (denoted as “t_{PDB}”) for the at least one data packet. The network device 120 may then determine the remaining delay budget may subtract the third time interval from the delay budget, t_{PDB}, for the at least one data packet. The remaining delay budget in this case may be determined as t_{PDB}−(t₄−t₀).
The at least one data packet may be associated with a delay budget, t_{PDB}, and the data packet may be considered as not useful if its delay exceeds the delay budget. In some embodiments, the delay budget, t_{PDB}, may be a packet delay budget (PDB) of a PDU, or a PDU set delay budget (PSDB) of a PDU set. In some embodiments, the delay budget, t_{PDB}, for the at least one data packet may be based on a service or application type, for example, based on a latency requirement of the service or application of the at least one data packet. In some embodiments, the delay budget, t_{PDB}, may be determined based on a value of a discard timer (e.g., discardTimer) of a protocol entity, such as of a PDCP entity. The expiration of the discard timer may be expiration of the delay budget. In some embodiments, the delay budget, tppB, may be a delay budget on the Uu interface or PDB or PSDB, which may be configured by the network device 120 or other network devices. The delay budget, t_{PDB}, may be configured for a service, for an application, for a data radio bearer (DRB), for a logical channel (LCH), for a logical channel group (LCG), for a packet data convergence protocol (PDCP) entity, or the like. The delay budget, t_{PDB}, for the at least one data packet may be determined in other suitable ways which is not limited here.

In some embodiments, the delay information reported by the terminal device 110 may indicate a first time interval between the arrival time (e.g., the time t₀ in FIG. 3) of the at least one data packet and a time when a BSR is transmitted (e.g., the time t₃ in FIG. 3). The first time interval of (t₃−t₀) may represent a delay of the at least one data packet when the BSR is transmitted by the terminal device 110. In some embodiments, the time when a BSR is transmitted may be the time for a new (or initial) transmission of the BSR.

At the side of the network device 120, it may determine the remaining delay budget based on the first time interval reported from the terminal device 110. Since the resource for the transmission of the BSR is allocated by the network device 120, it may also be aware of the time when a BSR is transmitted, e.g., the time t₃ in FIG. 3. The network device 120 may determine a time interval (referred to as a “fourth time interval” sometimes) between the time when the BSR is transmitted (e.g., the time t₃ in FIG. 3) and a time when the BSR is received (e.g., the time t₄ in FIG. 3), represented as (t₄−t₃). The network device 120 may determine the remaining delay budget for the at least one data packet by the delay budget, t_{PDB}, minus a sum of the first time interval of (t₃−t₀) and the fourth time interval of (t₄−t₃). The remaining delay budget in this case may be determined as t_{PDB}−(t₃−t₀)−(t₄−t₃).

In some embodiments, the delay information reported by the terminal device 110 may indicate a first result of the delay budget, t_{PDB}, minus the first time interval, (t₃−t₀). This first result may be represented as t_{PDB}−(t₃−t₀) and may represent a “remaining delay budget” of the at least one data packet when the BSR is transmitted, considering the delay of the at least one data packet before the BSR transmission. If the delay information indicates the first result, t_{PDB}−(t₃−t₀), the network device 120 may further determine the fourth time interval (t₄−t₃) between the time when the BSR is transmitted and a time when the BSR is received, and then determine the remaining delay budget as t_{PDB}−(t₃−t₀)−(t₄−t₃).

In some embodiments, the delay information reported by the terminal device 110 may indicate a second time interval between the arrival time (e.g., the time t₀ in FIG. 3) of the at least one data packet and a time when a resource for transmission of the BSR is granted (e.g., the time t₁ in FIG. 3). The second time interval of (t₁−t₀) may represent a delay of the at least one data packet when the resource for transmitting the BSR is granted.

The network device 120 may determine the remaining delay budget based on the second time interval reported from the terminal device 110. Since the resource for the transmission of the BSR is allocated by the network device 120, it may also be aware of the time when a resource for transmission of the BSR is granted, e.g., the time t₁ in FIG. 3. The network device 120 may determine a time interval (referred to as a “fifth time interval” sometimes) the time when the resource for transmission of the BSR is granted (e.g., the time t₁ in FIG. 3) and the time when the BSR is received (e.g., the time t₄ in FIG. 3), represented as (t₄−t₁). The network device 120 may determine the remaining delay budget for the at least one data packet by the delay budget, t_{PDB}, minus a sum of the second time interval of (t₁−t₀) and the fifth time interval of (t₄−t₁). The remaining delay budget in this case may be determined as t_{PDB}−(t₁−t₀)−(t₄−t₁).

In some embodiments, the delay information reported by the terminal device 110 may indicate a second result of the delay budget, t_{PDB}, minus the second time interval, (t₁−t₀). This second result may be represented as t_{PDB}−(t₁−t₀) and may represent a “remaining delay budget” of the at least one data packet when the resource for transmission of the BSR is granted, considering the delay of the at least one data packet before the resource grant for the BSR. If the delay information indicates the second result, t_{PDB}−(t₁−t₀), the network device 120 may further determine the fifth time interval (t₄−t₁) between the time when the resource for transmission of the BSR is granted and the time when the BSR is received. The network device 120 may then determine the remaining delay budget as t_{PDB}−(t₁−t₀)−(t₄−t₁).

There are some examples of delay information reported by the terminal device 110 to allow the network device 120 to determine the remaining delay budget. If the remaining delay budget is explicitly determined by the network device 120, it may have flexibility to schedule the uplink resources for data packet transmission considering the remaining delay budget without exceeding the delay budget of the data packets. The system capacity can be improved by prioritizing the scheduling of the corresponding delayed data.

In some embodiments, as mentioned above, the delay information may be comprised in a BSR and reported to the network device 120. The BSR comprising delay information may sometimes be referred to as a delayed BSR. In some embodiments, whether or not to report delay information or the delayed BSR may be configured by the network device 120. The terminal device 110 may receive, from the network device 120 or other network entity, configuration information indicating whether to report delay information (or a delayed BSR) for a DRB, a LCH, a LCG, a PDCP entity, or any other entity that is associated with a data packet(s). In the case that the configuration information indicates that the delay information is to be reported, the terminal device 110 may report delay information for at least one data packet that is corresponding to the DRB, the LCH, the LCG, the PDCP entity or the like.

In some embodiments, a delay threshold or a budget threshold may be configured for a DRB, a LCH, a LCG, a PDCP entity, or any other entity that is associated with a data packet(s). The terminal device 110 may receive, from the network device 120 or other network entity, configuration information indicating the delay threshold or the budget threshold. In some embodiments, if a delay of at least one data packet exceeds a delay threshold (referred to as a “first delay threshold” sometimes) or a remaining delay budget of at least one data packet is lower than a budget threshold (referred to as a “first budget threshold” sometimes), the terminal device 110 may determine that a report of the delay information or a delayed BSR may be triggered. The terminal device 110 may transmit the delay information to the network device 120.

At the side of the terminal device 110, the delay of the at least one data packet may be counted from the arrival time (e.g., the time t₀ in FIG. 3) of the at least one data packet, and the remaining delay budget may be determined by subtracting the delay from a delay budget of the at least one data packet.

In some examples, if a delay of a PDCP SDU or a PDU set exceeds the delay threshold, or a remaining delay budget of a PDCP SDU or a PDU set is less than the budget threshold, a PDCP entity of the terminal device 110 may indicate the lower layer (e.g., the MAC layer) to trigger a report of delay information (or a BSR). For the MAC layer, if an indication of triggering a report of delay information (or a BSR) is received from the upper layer (e.g., the PDCP layer), a report of delay information (or a BSR) may be triggered. In some embodiments, the trigger condition for a BSR may be specified in following Table 1.

TABLE 1
A BSR shall be triggered if any of the following events occur for activated cell group:

| | |
|---|---|
| - | ... ... |
| - | an indication of triggering a delay information report (or a BSR) is received from |
| | upper layer, in which case the BSR is referred below to as ‘Delayed BSR’. |

In some embodiments, all SDUs/PDUs belonging to a same PDU set may share the same arrival time from upper layer (equal to the arrival time of the first SDU/PDU belonging to a PDU set), and hence those SDUs/PDUs may have the same delay or remaining delay budget.

In some embodiments, if a BSR (e.g., a delayed BSR) is triggered because the delay of at least one data packet exceeds the corresponding delay threshold (or the remaining delay budget of the at least one data packet is less than the corresponding budget threshold, the terminal device 110 may include a delayed buffer size in the BSR to be reported. In some embodiments, the delayed buffer size may be determined based on at least one data packet of which a delay exceeds a second delay threshold or of which a remaining delay budget is lower than a second budget threshold. The second delay threshold may be the same or different from the first delay threshold which triggers the BSR, and similarly, the second budget threshold may be the same or different from the first budget threshold which triggers the BSR. In some examples, the calculation of the delayed buffer size at the PDCP layer may be specified in following Table 2, and the calculation of the delayed buffer size at a radio link control (RLC) layer may be specified in following Table 3.

TABLE 2
PDCP layer:
For the purpose of MAC delayed buffer status reporting, the transmitting PDCP entity shall consider at
least one of the following as PDCP data volume:

| | |
|---|---|
| - | the PDCP SDUs for which no PDCP Data PDUs have been constructed, and of which the delay |

exceeds the threshold;

| | |
|---|---|
| - | the PDCP Data PDUs that have not been submitted to lower layers, and of which the delay |

exceeds the threshold;

| | |
|---|---|
| - | for AM DRBs, the PDCP SDUs to be retransmitted according to clause 5.1.2, and of which the |

delay exceeds the threshold;

| | |
|---|---|
| - | for AM DRBs, the PDCP Data PDUs to be retransmitted according to clause 5.5, and |

of which the delay exceeds the threshold.

TABLE 3
RLC layer:
For the purpose of MAC delayed buffer status reporting, the UE shall consider at least
one of the following as RLC data volume:

| | |
|---|---|
| - | RLC SDUs and RLC SDU segments that have not yet been included in an RLC |

data PDU, and of which the delay exceeds the threshold;

| | |
|---|---|
| - | RLC data PDUs that are pending for initial transmission, and of which the delay |

exceeds the threshold;

| | |
|---|---|
| - | RLC data PDUs that are pending for retransmission (RLC AM), and of which the |

delay exceeds the threshold.

It is noted that “of which the delay exceeds the threshold” in Table 2 and/or Table 3 may also be replaced with “of which the remaining delay budget is less than the threshold”.

In some embodiments, if the delay information is comprised in a BSR (referred to as a “first BSR” sometimes), which may be referred to as a delayed BSR as mentioned above, this BSR may be defined to comprise a remaining delay budget or a reference time (e.g., an earliest arrival time, to). The remaining delay budget may be used to indicate the first result of the delay budget minus the first time interval, e.g., t_{PDB}−(t₃−t₀), the second result of the delay budget minus the second time interval, e.g., t_{PDB}−(t₁−t₀), or first time interval, e.g., t₃−t₀ or the second time interval, e.g., t₁−t₀. In some embodiments, this BSR may additionally or alternatively comprise a delayed buffer size. In some embodiments, this BSR may additionally or alternatively comprise an indication indicative of whether the delay information and/or the delayed buffer size is comprised in the first BSR. In some embodiments, the first BSR may comprise a BSR MAC CE.

In some embodiments, the delay information and/or the delayed buffer size may be reported per LCG in the first BSR (e.g., BSR MAC CE). The first BSR may comprise a first field indicating an identifier of a LCG whose delay information and/or delayed buffer size is being reported. The identifier of the LCG may be included, for example, in the BSR MAC CE. In some embodiments, a MAC subheader may comprise a logical channel identity (LCID) or an enhanced LCID (eLCID) value to identify the new BSR MAC CE.

In some embodiments, the first BSR may comprise a second field indicating the delay information for at least one data packet with a shortest remaining delay budget or an earliest reference time across logical channels of the LCG. For example, a Remaining Delay Budget field in the first BSR may indicate a remaining delay budget of the data packet (e.g., a PDCP SDU or a PDU set) with the shortest remaining delay budget across all logical channels of a LCG after the MAC PDU has been built (i.e., after the logical channel prioritization procedure). This field may be an index which points to a delay table. In another example, an Earliest Arrival Time in the first BSR may indicate the arrival time of the earliest data packet (e.g., a PDCP SDU or a PDU set) across all logical channels of a LCG after the MAC PDU has been built (i.e., after the logical channel prioritization procedure).

In some embodiments, the first BSR may further comprise a third field indicating the delayed buffer size for at least one data packet of which a delay exceeds a second delay threshold or of which a remaining delay budget is lower than a second budget threshold across logical channels of the LCG. For example, a Delayed Buffer Size field in the first BSR may indicate the total amount of available data that exceeds the delay threshold (or less than the budget threshold) according to the data volume calculation procedure (for example, according to the above Table 2 and/or Table 3) across all logical channels of a LCG after the MAC PDU has been built (i.e., after the logical channel prioritization procedure). The amount of data may be indicated in number of bytes. The size of the RLC headers and MAC subheaders may not be considered in the buffer size computation.

In some embodiments, the first BSR may further comprise a fourth field indicating the indication of whether the delay information and/or the delayed buffer size is comprised in the first BSR. This fourth field may be a new field introduced in a BSR, to indicate if 1) only the legacy buffer size, or 2) only delayed buffer size and/or remaining delay budget (or the earliest arrival time), or 3) both shall be reported for a LCG. In some embodiments, a reserved (R) field (e.g., a reserved bit) of the MAC header may be reused to indicate whether the delayed buffer size and/or the remaining delay budget (or the earliest arrival time) is included in the corresponding BSR.

The fields defined in the delayed BSR MAC CE may be defined as follows in Table 4.

TABLE 4
The fields in the new BSR MAC CE are defined as follows:

| | |
|---|---|
| - | Delayed Buffer Size: The Delayed Buffer Size field identifies the total amount of |
| | available data that exceeds the threshold (or less than the threshold) according |
| | to the data volume calculation procedure in TSs 38.322 and 38.323 across all |
| | logical channels of a logical channel group after the MAC PDU has been built |
| | (i.e. after the logical channel prioritization procedure). The amount of data is |
| | indicated in number of bytes. The size of the RLC headers and MAC subheaders |
| | are not considered in the buffer size computation. |
| - | Remaining Delay Budget: The Remaining Delay Budget field identifies the |
| | remaining delay budget of the UL packet (PDCP SDU or PDU Set) with the |
| | shortest remaining delay budget across all logical channels of a logical channel group |
| | after the MAC PDU has been built (i.e. after the logical channel prioritization |
| | procedure). The field may be an index which points to a delay table. |
| - | Earliest Arrival Time: The Earliest Arrival Time field identifies the arrival time |
| | of the earliest UL packet (PDCP SDU or PDU Set) across all logical channels of |
| | a logical channel group after the MAC PDU has been built (i.e. after the logical |
| | channel prioritization procedure). |

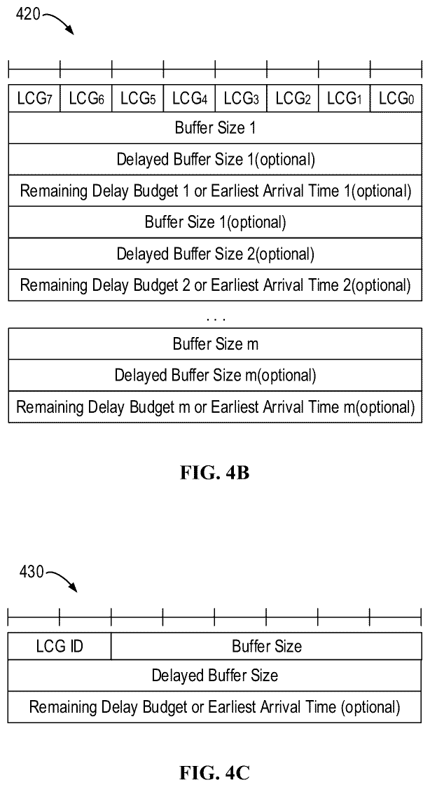

FIGS. 4A-4C illustrate example formats of BSR MAC CE in accordance with some embodiments of the present disclosure. It is noted that the size of each field is not specified in the figures and may be different. The figures are merely provided as illustrative examples.

FIG. 4A illustrates an example 410 of a BSR MAC CE Format 1. In this example, the LCG ID field identifies the LCG(s) which buffer status is being reported in the BSR MAC CE. As illustrated, eight bits for eight LCGs, LCG₀, LCG₁, . . . , LCG₇, are identified in the BSR and one or more bits of one or more LCGs which buffer status are being reported may be set to a value of “1” and the bits of other LCGs which buffer status are not reported may be set to a value of “0.” A Buffer Size field identifies the total amount of data available across all logical channels of a logical channel group after the MAC PDU has been built. The amount of data is indicated in number of bytes. There may be m Buffer Size fields if the LCG ID field indicates that the buffer status of m LCGs are being reported.

Further, in the example of FIG. 4A, optional fields for the delayed buffer size, and the remaining delay budget or earliest arrival time may follows the Buffer Size fields in the BSR. For each LCG of the m LCGs which buffer status is being reported, a Delayed Buffer Size field (if being included) and a Remaining Delay Budget or Earliest Arrival Time field (if being included) may be adjacent with each other.

FIG. 4B illustrates an example 420 of a BSR MAC CE Format 2. Different from the example of FIG. 4A, in the example of FIG. 4B, the Buffer Size field, the Delayed Buffer Size field (if being included) and the Remaining Delay Budget or Earliest Arrival Time field (if being included) for a certain LCG may be arranged as consecutive fields, followed by the three similar fields for another LCG.

FIG. 4C illustrates an example 430 of a BSR MAC CE Format 3 which is a short BSR MAC CE. In this example, a LCG ID field identifies the LCG, and a Buffer Size field indicates the corresponding buffer size for the identified LCG. Further, a Delayed Buffer Size field (if being included) and a Remaining Delay Budget or Earliest Arrival Time field (if being included) for the identified LCG may be included and immediately follow the Buffer Size field.

In some embodiments, the delay information and/or the delayed buffer size may be reported per LCH in the first BSR (e.g., BSR MAC CE). The first BSR may comprise a first field indicating an identifier of a LCH whose delay information and/or delayed buffer size is being reported. In some embodiments, the identifier of the LCH may be included, for example, in the BSR MAC CE. In some embodiments, a MAC subheader may comprise a LCID or an eLCID value to identity the new BSR MAC CE. In some embodiments, a Logical Channel ID field may be included in the first BSR to identify the logical channel instance whose delayed buffer size is reported. In some embodiments, a LCIDi field may be included in the first BSR and may be mapped to a logical channel instance whose delayed buffer size is reported.

In some embodiments, the first BSR may comprise a second field indicating the delay information for at least one data packet with a shortest remaining delay budget or an earliest reference time for the LCH. For example, a Remaining Delay Budget field in the first BSR may indicate a remaining delay budget of the UL packet (e.g., a PDCP SDU or a PDU set) with the shortest remaining delay budget for the corresponding logical channel after the MAC PDU has been built (i.e. after the logical channel prioritization procedure). This field may be an index which points to a delay table. In another example, an Earliest Arrival Time in the first BSR may indicate the arrival time of the earliest data packet (e.g., a PDCP SDU or a PDU set) for the corresponding logical channel after the MAC PDU has been built (i.e., after the logical channel prioritization procedure).

In some embodiments, the first BSR may further comprise a second field indicating the delayed buffer size for at least one data packet of which a delay exceeds a second delay threshold or of which a remaining delay budget is lower than a second budget threshold for the corresponding LCH. For example, a Delayed Buffer Size field in the first BSR may indicate the total amount of available data that exceeds the threshold (or less than the threshold) according to the data volume calculation procedure (for example, according to the above Table 2 and/or Table 3) for the corresponding logical channel after the MAC PDU has been built (i.e. after the logical channel prioritization procedure). The amount of data is indicated in number of bytes. The size of the RLC headers and MAC subheaders are not considered in the buffer size computation.

In some embodiments, the first BSR may further comprise a fourth field indicating the indication of whether the delay information and/or the delayed buffer size is comprised in the first BSR. This fourth field may be a new field introduced in a BSR, to indicate if 1) only the legacy buffer size, or 2) only delayed buffer size and/or remaining delay budget (or the earliest arrival time), or 3) both shall be reported for a LCH. In some embodiments, a reserved (R) field (e.g., a reserved bit) of the MAC header may be reused to indicate whether the delayed buffer size and/or the remaining delay budget (or the earliest arrival time) is included in the corresponding BSR.

The fields defined in the delayed BSR MAC CE may be defined as follows in Table 5.

TABLE 5
The fields in the new BSR MAC CE are defined as follows:

| | |
|---|---|
| - | Logical Channel ID (LCID) or LCIDi: The Logical Channel ID field identifies |
| | the logical channel instance whose Delayed Buffer Size is reported. The LCIDi |
| | field is mapped to a logical channel instance whose Delayed Buffer Size is |
| | reported. |
| - | Delayed Buffer Size: The Delayed Buffer Size field identifies the total amount of |
| | available data that exceeds the threshold (or less than the threshold) according |
| | to the data volume calculation procedure in TSs 38.322 and 38.323 for the |
| | corresponding logical channel after the MAC PDU has been built (i.e. after the |
| | logical channel prioritization procedure). The amount of data is indicated in number |
| | of bytes. The size of the RLC headers and MAC subheaders are not considered |
| | in the buffer size computation. |
| - | Remaining Delay Budget: The Remaining Delay Budget field identifies the |
| | remaining delay budget of the UL packet (PDCP SDU or PDU Set) with the |
| | shortest remaining delay budget for the corresponding logical channel after the MAC |
| | PDU has been built (i.e. after the logical channel prioritization procedure). The |
| | field may be an index which points to a delay table. |
| - | Earliest Arrival Time: The Earliest Arrival Time field identifies the arrival time |
| | of the earliest UL packet (PDCP SDU or PDU Set) for the corresponding logical |
| | channel after the MAC PDU has been built (i.e. after the logical channel |
| | prioritization procedure). |

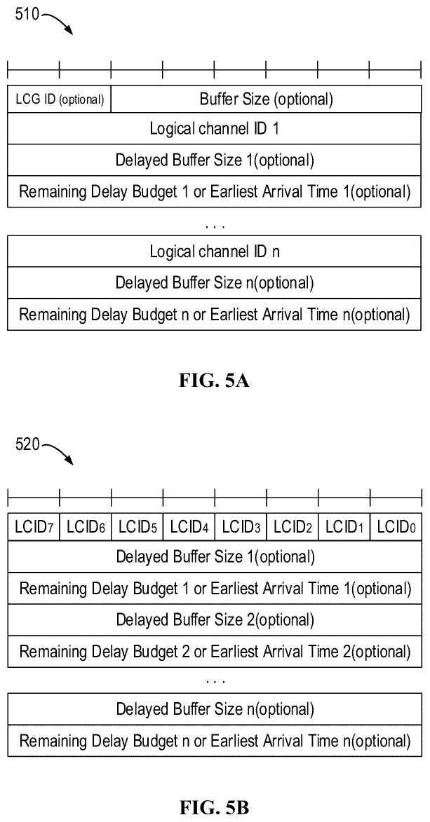

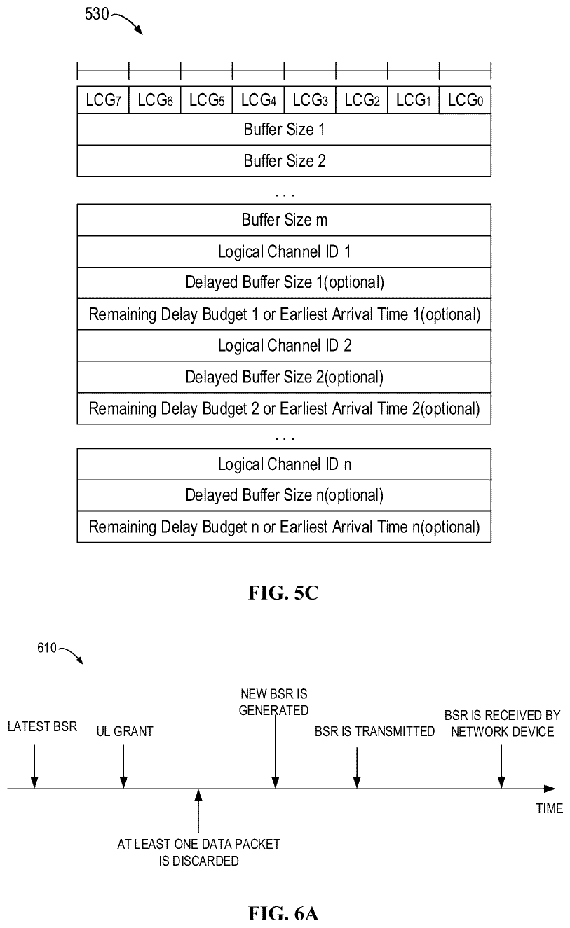

FIGS. 5A-5C illustrate example formats of BSR MAC CE in accordance with some embodiments of the present disclosure. It is noted that the size of each field is not specified in the figures and may be different. The figures are merely provided as illustrative examples.

FIG. 5A illustrates an example 510 of a BSR MAC CE Format 1. In this example, a LCG ID field (which is optional) identifies a LCG which buffer status is being reported and a Buffer Size field indicates the corresponding buffer size for the identified LCG. Further, the BSR comprises a Logical Channel ID field to identify the logical channel instance whose Delayed Buffer Size and/or delay information is reported. A Delayed Buffer Size field (if being included) and a Remaining Delay Budget or Earliest Arrival Time field (if being included) for the identified LCG for the corresponding logical channel may immediately follow the Logical Channel ID field. If information for more than one logical channels are being reported, similar Logical Channel ID, Delayed Buffer Size, and Remaining Delay Budget or Earliest Arrival Time fields may be included in the BSR. In the example of FIG. 5A, it is assumed that the Delayed Buffer Size and/or delay information for a total of n logical channels are being reported. In this example, the Delayed Buffer Size field (if being included) and the Remaining Delay Budget or Earliest Arrival Time field (if being included) for a certain LCH may be arranged as consecutive fields after the Logical Channel ID field, followed by another Logical Channel ID field (if any).

FIG. 5B illustrates an example 520 of a BSR MAC CE Format 2. In this example, the LCIDi field identifies the LCH(s) which Delayed Buffer Size and/or delay information is being reported. As illustrated, a field including eight bits for eight LCIDs, i.e., LCID₀, LCID₁, . . . , LCG₇, is included in the BSR and one or more bits of one or more LCHs which delayed buffer size and/or delay information are being reported may be set to a value of “1” and the bits of other LCHs which Delayed Buffer Size and/or delay information are not reported may be set to a value of “0.” There may be m Delayed Buffer Size fields and m Remaining Delay Budget or Earliest Arrival Time fields if the LCID field indicates that the buffer status of m LCHs are being reported. In this example, the Delayed Buffer Size field (if being included) and the Remaining Delay Budget or Earliest Arrival Time field (if being included) for a certain LCH may be arranged as consecutive fields, followed by two similar fields for another LCH.

FIG. 5C illustrates an example 530 of a BSR MAC CE Format 3. In this example, the LCG ID field and the Buffer Size fields are similar as the example of FIG. 4A. The BSR may be defined to further comprise a Logical Channel ID field to identify the logical channel instance whose Delayed Buffer Size and/or delay information is reported. A Delayed Buffer Size field (if being included) and a Remaining Delay Budget or Earliest Arrival Time field (if being included) for the identified LCG for the corresponding logical channel may immediately follow the Logical Channel ID field. If information for more than one logical channels are being reported, similar Logical Channel ID, Delayed Buffer Size, and Remaining Delay Budget or Earliest Arrival Time fields may be included in the BSR. In the example of FIG. 5C, it is assumed that the Delayed Buffer Size and/or delay information for a total of n logical channels are being reported.

It would be appreciates that some example formats for BSR MAC CE are illustrated. Various other formats may be defined to carry the delay information, the remaining delay budget or earliest arrival time, the delayed buffer size, and/or other delay related information according to embodiments of the present disclosure.

In some embodiments, the first BSR (e.g., delayed BSR) which comprises the delayed delay information, the remaining delay budget or earliest arrival time, the delayed buffer size, and/or other delay related information may be transmitted with a relatively high priority. For example, the first BSR may be transmitted with a higher priority than a priority of a second BSR without delay information for a data packet. The second BSR may be, for example, a regular BSR or a periodic BSR. The trigger for reporting a BSR at the MC entity may be specified as follows in Table 6.

TABLE 6
For Delayed, Regular and Periodic BSR, the MAC entity for which logicalChannelGroup-IAB-
Ext is not configured by upper layers shall:

| | |
|---|---|
| 1> | if at least one LCG has delayed data available for transmission when the MAC PDU |

containing the BSR is to be built:

| | |
|---|---|
| | 2> report delayed BSR for all LCGs which have delayed data available for transmission. |
| 1> | else if more than one LCG has data available for transmission when the MAC PDU con- |

taining the BSR is to be built:

| | |
|---|---|
| | 2> report Long BSR for all LCGs which have data available for transmission. |
| 1> | else: |
| | 2> report Short BSR. |

In some cases, discarding packets in the transmitter will make the previous BSR obsolete and may lead to scheduling more resources than needed, which in turn increases power consumption and decreases the overall cell capacity.

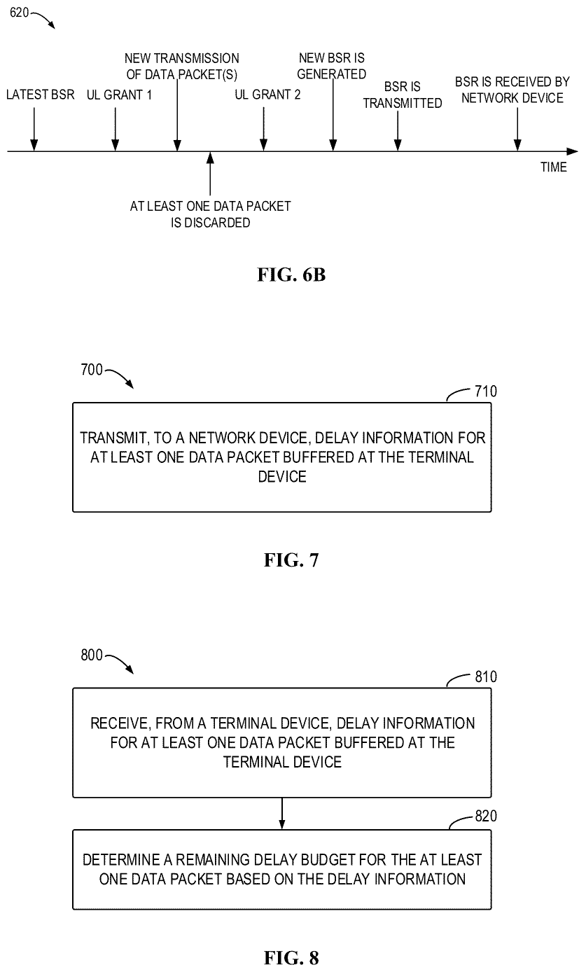

FIG. 6A illustrates an example timeline 610 showing various events occurred from the time when a latest BSR is transmitted to the time when a new BSR is received by the network device. As illustrated, after a latest BSR is transmitted before a new BSR is generated and transmitted according to the received UL grant, one or more data packets may be discarded for the reason of the corresponding discard timer being expired or other reasons (e.g., lower priority or important data is discarded when congestion happens).

By taking the discarding of the data packet(s) into account, in some embodiments of the present disclosure, it is proposed to trigger a BSR when one or more data packets are discarded, especially when one or more PDU sets are discarded. Generally, since a PDU set may comprise a relatively large size of data, discarding a PDU set or part of a PDU set may have a large impact on the buffer size. According to the embodiments of the present disclosure, by triggering a BSR when one or more data packets are discarded, it is possible to avoid scheduling more resources than needed, thus saving power consumption and increasing overall cell capacity.

In some embodiments, at the PDCP layer of the terminal device 110, if at least one buffered data packet (e.g., at least one PDCP SDU or PDU set) is discarded by the PDCP entity, the PDCP entity may send a first indication of packet discarding or a second indication of triggering a BSR to a lower layer, e.g., the MAC layer. That is, the packet discarding may be considered as a BSR trigger event.

In some embodiments, at the MAC layer, in upon receipt of the first indication of packet discarding or the second indication of triggering a BSR from the PDCP layer, the MAC entity of the terminal device 110 may determine a buffer size for a LCH or a LCG corresponding to the at least one discarded buffered data packet. The MAC entity may trigger a BSR to be reported if the calculated buffer size meets one or more conditions.

In some embodiments, if the buffer size is different from (e.g., lower than) a latest reported buffer size for the LCH or LCG (e.g., in the lasted BSR), then the MAC entity of the terminal device 110 may trigger a BSR (e.g., a delayed BSR or other types of BSR).

In some embodiments, if the buffer size is different from (e.g., lower than) a latest reported buffer size for the LCH or LCG (e.g., in the lasted BSR), and if a first quantization level of the buffer size is different from a second quantization level of the latest reported buffer size, then the MAC entity of the terminal device 110 may trigger a BSR (e.g., a delayed BSR or other types of BSR). Generally, the terminal device 110 may map a buffer size or a buffer size to a certain quantization level (also referred to as a “Buffer size level”) according to a mapping table. This mapping table may comprise certain indexes mapped to certain buffer size values. Since an index (or a quantization level) may be mapped to a certain range of buffer size, it will make sense if the MAC entity trigger a BSR in the case that the quantization level after the packet discarding changes (e.g., the index of the buffer size in the mapping table is different). In some embodiments, the triggered BSR may be a regular BSR.

In some embodiments, since the quantization step of buffer size is small when index of buffer size table is small, a reference quantization level (e.g., an index mapped to the buffer size) may be configured for the terminal device 110. If the quantization level of the latest reported buffer size is equal to or higher than the reference quantization level, the MAC entity of the terminal device 110 may trigger the BSR when determining that the buffer size is different from (e.g., lower than) a latest reported buffer size for the LCH or LCG (e.g., in the lasted BSR), and the first quantization level of the buffer size is different from the second quantization level of the latest reported buffer size.

In some embodiments, alternatively or in addition, the MAC entity of the terminal device 110 may trigger the BSR if the buffer size after the packet discarding is different from (e.g., lower than) a latest reported buffer size for the LCH or LCG (e.g., in the lasted BSR), and if a difference between the buffer size and the latest reported buffer size exceeds a difference threshold (and/or the difference of the quantization level exceeds a certain difference threshold), where the difference threshold may be configured.

In some embodiments, alternatively or in addition, the MAC entity of the terminal device 110 may trigger the BSR if the buffer size after the packet discarding is equal to zero.

In some cases, during the time period between the latest reported BSR and a new generated BSR, there may be one or more new transmissions that carries some data packets of the LCG or LCH before the new BSR is generated, as illustrated by the timeline 620 in FIG. 6B. If these data packets are not considered when comparing the latest reported buffer size with the new calculated buffer size, then the difference between them is not accurate.

In some embodiments, in addition to considering the at least one discarded buffered data packet, the buffer size may be determined based on at least one data packet corresponding to the LCH or the LCG that has been transmitted after a last reported BSR. That is, for a LCH or a LCG, the size of data that has been transmitted between the latest reported BSR and a newly generated BSR may be considered when comparing the latest reported buffer size with the newly calculated buffer size. For example, the newly calculated buffer size may be compared with the “latest reported buffer size” minus “the size of data that has been transmitted between latest reported BSR and newly generated BSR”.

FIG. 7 illustrates a flowchart of a method 700 implemented at a terminal device in accordance with some embodiments of the present disclosure. For the purpose of discussion, the method 700 will be described from the perspective of the terminal device 110 in FIG. 1.

At block 710, the terminal device 110 transmits, to a network device (e.g., the network device 120), delay information for at least one data packet buffered at the terminal device. The delay information indicates at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval.

In some embodiments, the reference time comprises an arrival time of the at least one data packet at an access stratum (AS) layer.

In some embodiments, the delay budget for the at least one data packet is determined based on a value of a discard timer for the at least one packet or is configured on a radio interface.

In some embodiments, the terminal device 110 may further receive, from the network device, configuration information indicating whether to report delay information for a data radio bearer (DRB), a logical channel, a logical channel group (LCG), or a packet data convergence protocol (PDCP) entity; and in accordance with a determination that the configuration information indicates that the delay information is to be reported, transmit the delay information to the network device.

In some embodiments, in accordance with a determination that a delay of the at least one data packet exceeds a first delay threshold or a remaining delay budget of the at least one data packet is lower than a first budget threshold, the terminal device 110 may transmit the delay information to the network device.

In some embodiments, the delay information is comprised in a first BSR, and the first BSR further comprises at least one of the following: a remaining delay budget, an earliest arrival time, a delayed buffer size, or an indication indicative of whether the delay information and/or the delayed buffer size is comprised in the first BSR.

In some embodiments, the delayed buffer size is determined based on at least one data packet of which a delay exceeds a second delay threshold or of which a remaining delay budget is lower than a second budget threshold.

In some embodiments, the first BSR comprises a first field indicating an identifier of a logical channel group (LCG), and a second field indicating the delay information for at least one data packet with a shortest remaining delay budget or an earliest reference time across logical channels of the LCG. In some embodiments, the first BSR further comprises at least one of the following: third field indicating the delayed buffer size for at least one data packet of which a delay exceeds a second delay threshold or of which a remaining delay budget is lower than a second budget threshold across logical channels of the LCG, or a fourth field indicating the indication of whether the delay information and/or the delayed buffer size is comprised in the first BSR.

In some embodiments, the first BSR comprises a first field indicating an identifier of a logical channel (LCH), and a second field indicating the delay information for at least one data packet with a shortest remaining delay budget or an earliest reference time for the LCH. In some embodiments, the first BSR further comprises at least one of the following: a third field indicating the delayed buffer size for at least one data packet of which a delay exceeds a second delay threshold or of which a remaining delay budget is lower than a second budget threshold for the LCH, or a fourth field indicating the indication of whether the delay information and/or the delayed buffer size is comprised in the first BSR.

In some embodiments, the delay information is comprised in a first BSR, and the first BSR is transmitted with a higher priority than a priority of a second BSR without delay information for a data packet.

In some embodiments, in accordance with a determination that at least one buffered data packet is discarded, the terminal device 110 may send, from a packet data convergence protocol (PDCP) entity to a medium access control (MAC) entity, a first indication of packet discarding or a second indication of triggering a BSR.

In some embodiments, upon receipt of the first indication or the second indication, the terminal device 110 may further determine, by the MAC entity, a buffer size for a LCH or a LCG corresponding to the at least one discarded buffered data packet; and trigger, by the MAC entity, a BSR to be reported in accordance with a determination of at least one of the following: the buffer size is different from a latest reported buffer size for the LCH or LCG, a first quantization level of the buffer size is different from a second quantization level of the latest reported buffer size, the second quantization level is equal to or higher than a reference quantization level, a difference between the buffer size and the latest reported buffer size exceeds a difference threshold, or the buffer size is equal to zero.

In some embodiments, the buffer size is determined based on at least one data packet corresponding to the LCH or the LCG that has been transmitted after a last reported BSR and the at least one discarded buffered data packet.

FIG. 8 illustrates a flowchart of a method 800 implemented at a network device in accordance with some embodiments of the present disclosure. For the purpose of discussion, the method 800 will be described from the perspective of the network device 120 in FIG. 1.

At block 810, the network device 120 receives, from a terminal device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval. At block 820, the network device 120 determines a remaining delay budget for the at least one data packet based on the delay information.

In some embodiments, the reference time comprises an arrival time of the at least one data packet at an access stratum (AS) layer.

In some embodiments, in accordance with a determination that the delay information indicates the reference time, the network device 120 may determine the remaining delay budget by the delay budget for the at least one data packet minus a third time interval between the reference time and a time when the BSR is received.

In some embodiments, in accordance with a determination that the delay information indicates the first result, the network device 120 may determine the remaining delay budget by the first result minus a fourth time interval between the time when the BSR is transmitted and a time when the BSR is received.

In some embodiments, in accordance with a determination that the delay information indicates the first time interval, the network device 120 may determine the remaining delay budget by the delay budget minus a sum of the first time interval and the fourth time interval.

In some embodiments, in accordance with a determination that the delay information indicates the second result, the network device 120 may determine the remaining delay budget by the second result minus a fifth time interval between the time when the resource for transmission of the BSR is granted and the time when the BSR is received.

In some embodiments, in accordance with a determination that the delay information indicates the second time interval, the network device 120 may determine the remaining delay budget by the delay budget minus a sum of the second time interval and the fifth time interval.

In some embodiments, the delay budget for the at least one data packet is determined based on a value of a discard timer for the at least one packet or is configured on a radio interface.

In some embodiments, the network device 120 may further transmit, from the terminal device, configuration information indicating whether to report delay information for a data radio bearer (DRB), a logical channel, a logical channel group (LCG), or a packet data convergence protocol (PDCP) entity corresponding to the at least one data packet. In accordance with a determination that the configuration information indicates that the delay information is to be reported, the network device 120 may receive the delay information from the terminal device.

In some embodiments, the delay information is comprised in a first BSR, and the first BSR further comprises at least one of the following: a remaining delay budget, an earliest arrival time, a delayed buffer size, or an indication of whether the delay information and/or the delayed buffer size is comprised in the first BSR.

In some embodiments, the delayed buffer size is determined based on at least one data packet of which a delay exceeds a second delay threshold or of which a remaining delay budget is lower than a second budget threshold.

In some embodiments, the first BSR comprises a first field indicating an identifier of a logical channel group (LCG), and a second field indicating the delay information for at least one data packet with a shortest remaining delay budget or an earliest reference time across logical channels of the LCG. In some embodiments, the first BSR further comprises at least one of the following: a third field indicating the delayed buffer size for at least one data packet of which a delay exceeds a second delay threshold or of which a remaining delay budget is lower than a second budget threshold across logical channels of the LCG, or a fourth field indicating the indication of whether the delay information and/or the delayed buffer size is comprised in the first BSR.

In some embodiments, the first BSR comprises a first field indicating an identifier of a logical channel (LCH), and a second field indicating the delay information for at least one data packet with a shortest remaining delay budget or an earliest reference time for the LCH. In some embodiments, the first BSR further comprises at least one of the following: a third field indicating the delayed buffer size for at least one data packet of which a delay exceeds a second delay threshold or of which a remaining delay budget is lower than a second budget threshold for the LCH, or a fourth field indicating the indication of whether the delay information and/or the delayed buffer size is comprised in the first BSR.

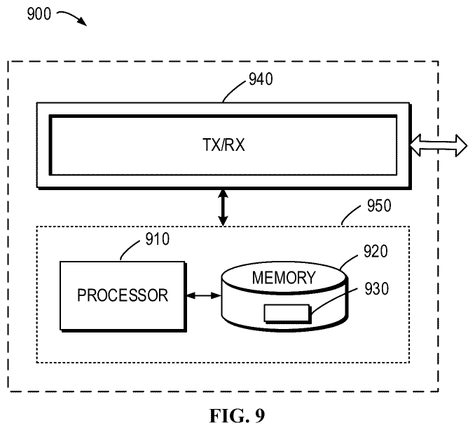

FIG. 9 is a simplified block diagram of a device 900 that is suitable for implementing embodiments of the present disclosure. The device 900 can be considered as a further example implementation of any of the devices as shown in FIG. 1. Accordingly, the device 900 can be implemented at or as at least a part of the terminal device 110 or the network device 120.

As shown, the device 900 includes a processor 910, a memory 920 coupled to the processor 910, a suitable transmitter (TX)/receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises a circuitry configured to transmit, to a network device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval. According to embodiments of the present disclosure, the circuitry may be configured to perform any of the method implemented by the terminal device as discussed above.

In some embodiments, a network device comprises a circuitry configured to: receive, from a terminal device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or second result of the delay budget for the at least one data packet minus the second time interval; and determine a remaining delay budget for the at least one data packet based on the delay information. According to embodiments of the present disclosure, the circuitry may be configured to perform any of the method implemented by the network device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a terminal device comprises: a processor configured to cause the terminal device to: transmit, to a network device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval.

In some embodiments, the reference time comprises an arrival time of the at least one data packet at an access stratum (AS) layer.

In some embodiments, the delay budget for the at least one data packet is determined based on a value of a discard timer for the at least one packet or is configured on a radio interface.

In some embodiments, the processor is further configured to cause the terminal device to: receive, from the network device, configuration information indicating whether to report delay information for a data radio bearer (DRB), a logical channel, a logical channel group (LCG), or a packet data convergence protocol (PDCP) entity; and in accordance with a determination that the configuration information indicates that the delay information is to be reported, transmit the delay information to the network device.

In some embodiments, the processor is further configured to cause the terminal device to: in accordance with a determination that a delay of the at least one data packet exceeds a first delay threshold or a remaining delay budget of the at least one data packet is lower than a first budget threshold, transmit the delay information to the network device.

In some embodiments, the delay information is comprised in a first BSR, and the first BSR further comprises at least one of the following: a remaining delay budget, an earliest arrival time, a delayed buffer size, or an indication indicative of whether the delay information and/or the delayed buffer size is comprised in the first BSR.

In some embodiments, the delayed buffer size is determined based on at least one data packet of which a delay exceeds a second delay threshold or of which a remaining delay budget is lower than a second budget threshold.

In some embodiments, the first BSR comprises a first field indicating an identifier of a logical channel group (LCG), and a second field indicating the delay information for at least one data packet with a shortest remaining delay budget or an earliest reference time across logical channels of the LCG, and wherein the first BSR further comprises at least one of the following: a third field indicating the delayed buffer size for at least one data packet of which a delay exceeds a second delay threshold or of which a remaining delay budget is lower than a second budget threshold across logical channels of the LCG, or a fourth field indicating the indication of whether the delay information and/or the delayed buffer size is comprised in the first BSR.

In some embodiments, the first BSR comprises a first field indicating an identifier of a logical channel (LCH), and a second field indicating the delay information for at least one data packet with a shortest remaining delay budget or an earliest reference time for the LCH, and wherein the first BSR further comprises at least one of the following: a third field indicating the delayed buffer size for at least one data packet of which a delay exceeds a second delay threshold or of which a remaining delay budget is lower than a second budget threshold for the LCH, or a fourth field indicating the indication of whether the delay information and/or the delayed buffer size is comprised in the first BSR.

In some embodiments, the delay information is comprised in a first BSR, and the first BSR is transmitted with a higher priority than a priority of a second BSR without delay information for a data packet.

In some embodiments, the processor is further configured to cause the terminal device to: in accordance with a determination that at least one buffered data packet is discarded, send, from a packet data convergence protocol (PDCP) entity to a medium access control (MAC) entity, a first indication of packet discarding or a second indication of triggering a BSR.

In some embodiments, the processor is further configured to cause the terminal device to: upon receipt of the first indication or the second indication, determine, by the MAC entity, a buffer size for a LCH or a LCG corresponding to the at least one discarded buffered data packet; and trigger, by the MAC entity, a BSR to be reported in accordance with a determination of at least one of the following: the buffer size is different from a latest reported buffer size for the LCH or LCG, a first quantization level of the buffer size is different from a second quantization level of the latest reported buffer size, the second quantization level is equal to or higher than a reference quantization level, a difference between the buffer size and the latest reported buffer size exceeds a difference threshold, or the buffer size is equal to zero.

In some embodiments, the buffer size is determined based on at least one data packet corresponding to the LCH or the LCG that has been transmitted after a last reported BSR and the at least one discarded buffered data packet.

In an aspect, a network device comprises: a processor configured to cause the network device to: receive, from a terminal device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval; and determine a remaining delay budget for the at least one data packet based on the delay information.

In some embodiments, the reference time comprises an arrival time of the at least one data packet at an access stratum (AS) layer.

In some embodiments, the processor is further configured to cause the network device to: in accordance with a determination that the delay information indicates the reference time, determine the remaining delay budget by the delay budget for the at least one data packet minus a third time interval between the reference time and a time when the BSR is received; in accordance with a determination that the delay information indicates the first result, determine the remaining delay budget by the first result minus a fourth time interval between the time when the BSR is transmitted and a time when the BSR is received; in accordance with a determination that the delay information indicates the first time interval, determine the remaining delay budget by the delay budget minus a sum of the first time interval and the fourth time interval; in accordance with a determination that the delay information indicates the second result, determine the remaining delay budget by the second result minus a fifth time interval between the time when the resource for transmission of the BSR is granted and the time when the BSR is received; and in accordance with a determination that the delay information indicates the second time interval, determine the remaining delay budget by the delay budget minus a sum of the second time interval and the fifth time interval.

In some embodiments, the delay budget for the at least one data packet is determined based on a value of a discard timer for the at least one packet or is configured on a radio interface.

In some embodiments, the processor is further configured to cause the network device to: transmit, from the terminal device, configuration information indicating whether to report delay information for a data radio bearer (DRB), a logical channel, a logical channel group (LCG), or a packet data convergence protocol (PDCP) entity corresponding to the at least one data packet; and in accordance with a determination that the configuration information indicates that the delay information is to be reported, receive the delay information from the terminal device.

In some embodiments, the delay information is comprised in a first BSR, and the first BSR further comprises at least one of the following: a remaining delay budget, an earliest arrival time, a delayed buffer size, or an indication of whether the delay information and/or the delayed buffer size is comprised in the first BSR.

In some embodiments, the delayed buffer size is determined based on at least one data packet of which a delay exceeds a second delay threshold or of which a remaining delay budget is lower than a second budget threshold.

In some embodiments, the first BSR comprises a first field indicating an identifier of a logical channel group (LCG), and a second field indicating the delay information for at least one data packet with a shortest remaining delay budget or an earliest reference time across logical channels of the LCG, and wherein the first BSR further comprises at least one of the following: a third field indicating the delayed buffer size for at least one data packet of which a delay exceeds a second delay threshold or of which a remaining delay budget is lower than a second budget threshold across logical channels of the LCG, or a fourth field indicating the indication of whether the delay information and/or the delayed buffer size is comprised in the first BSR.

In some embodiments, the first BSR comprises a first field indicating an identifier of a logical channel (LCH), and a second field indicating the delay information for at least one data packet with a shortest remaining delay budget or an earliest reference time for the LCH, and wherein the first BSR further comprises at least one of the following: a third field indicating the delayed buffer size for at least one data packet of which a delay exceeds a second delay threshold or of which a remaining delay budget is lower than a second budget threshold for the LCH, or a fourth field indicating the indication of whether the delay information and/or the delayed buffer size is comprised in the first BSR.

In an aspect, a communication method comprises: transmitting, from a terminal device and to a network device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus the first time interval, a second time interval between the arrival time of the at least one data packet and a time when a resource for transmission of the BSR is granted, or a second result of the delay budget for the at least one data packet minus the second time interval.

In an aspect, a communication method comprises: receiving, at a network device and from a terminal device, delay information for at least one data packet buffered at the terminal device, the delay information indicating at least one of the following: a reference time related to buffering of the at least one data packet, a first time interval between an arrival time of the at least one data packet and a time when a buffer status report (BSR) is transmitted, a first result of a delay budget for the at least one data packet minus a first time interval between an arrival time of the at least one data packet and a time when a buffer status report (BSR) is transmitted, a second time interval between the arrival time of the at least one data packet and a time when a resource for transmission of the BSR is granted, or a second result of the delay budget for the at least one data packet minus the second time interval; and determine a remaining delay budget for the at least one data packet based on the delay information.

In an aspect, a terminal device comprises: at least one processor; and at least one memory coupled to the at least one processor and storing instructions thereon, the instructions, when executed by the at least one processor, causing the device to perform the method implemented by the terminal device discussed above.

In an aspect, a network device comprises: at least one processor; and at least one memory coupled to the at least one processor and storing instructions thereon, the instructions, when executed by the at least one processor, causing the device to perform the method implemented by the network device discussed above.

In an aspect, a computer readable medium having instructions stored thereon, the instructions, when executed on at least one processor, causing the at least one processor to perform the method implemented by the terminal device discussed above.

In an aspect, a computer readable medium having instructions stored thereon, the instructions, when executed on at least one processor, causing the at least one processor to perform the method implemented by the network device discussed above.

In an aspect, a computer program comprising instructions, the instructions, when executed on at least one processor, causing the at least one processor to perform the method implemented by the terminal device discussed above.

In an aspect, a computer program comprising instructions, the instructions, when executed on at least one processor, causing the at least one processor to perform the method implemented by the network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 8-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a User Equipment (UE) comprising:
receiving configuration information for a status report, and
transmitting, to a base station, the status report of buffered data, wherein the status report comprises the smallest remaining value of running Packet Data Convergence Protocol (PDCP) discard timers among PDCP Service Data Units (SDUs).

22. The method of claim 21, wherein:
the configuration information comprises threshold information, and
wherein the transmission is based on the threshold information.

23. The method of claim 22, wherein:
in a case where the smallest remaining value becomes below the threshold information, the status report is transmitted.

24. The method of claim 21, wherein:
the status report is transmitted via a Medium Access Control (MAC) Control Element (CE) and the smallest remaining value is a value at a time of a first uplink transmission for the status report.

25. The method of claim 21, wherein:
the configuration information comprises an identifier for a Logical Channel Group (LCG) related to the status report.

26. A User Equipment (UE) comprising:
a memory storing instructions; and
a processor configured to execute the instructions to:
receive configuration information for a status report, and
transmit, to a base station, the status report of buffered data, wherein the status report comprises the smallest remaining value of running Packet Data Convergence Protocol (PDCP) discard timers among PDCP Service Data Units (SDUs).

27. The UE of claim 26, wherein:
the configuration information comprises threshold information, and
wherein the transmission is based on the threshold information.

28. The UE of claim 27 wherein:
in a case where the smallest remaining value becomes below the threshold information, the status report is transmitted.

29. The UE of claim 26, wherein:
the smallest remaining value is transmitted via a Medium Access Control (MAC) Control Element (CE) and is a value at a time of a first uplink transmission for the status report.

30. The UE of claim 26, wherein:
the configuration information comprises an identifier for a Logical Channel Group (LCG) related to the status report.
